(19) United States
(12) Patent Application Publication
(10) Pub. No.: US 2005/0174446 A1
(43) Pub. Date: Aug. 11, 2005

(54) Image sensing apparatus

(76) Inventor: Emi Hitosuga, Tokyo (JP)

Correspondence Address: MORGAN & FINNEGAN, L.L.P., 3 WORLD FINANCIAL CENTER, NEW YORK, NY, 10281-2101, US

(21) Appl. No.: 11/051,369

(22) Filed: Feb. 4, 2005

(30) Foreign Application Priority Data
Feb. 6, 2004 (JP) 2004-031406
Jan. 31, 2005 (JP) 2005-023940

(51) Int. Cl. H04N 5/76

(52) U.S. Cl. 348/231.8

(57) ABSTRACT

An image sensing apparatus having a plurality of slots for inserting storage medium includes an interface for setting one or more recording slots for recording image data acquired by photography. In the setting of the recording slots, whether or not image data can be recorded to storage media in the recording slot or slots is detected, and the apparatus is controlled so that those slots for which recording to the storage media is not possible are not set as recording slots.

### FIELD OF THE INVENTION

The present invention relates to an image sensing apparatus such as a digital camera, a digital video camera and a camera-equipped mobile telephone (camera phone).

### BACKGROUND OF THE INVENTION

Digital cameras that photograph still images and moving images, digitize the photographs and then store them on storage media, have come into very widespread use. At present, such digital cameras are typically equipped with only a single media slot for the insertion of a storage medium. However, there also exist digital cameras capable of handing a plurality of storage media, for the purpose of recording a photographed image on a plurality of storage media, backing up a photographed image, and so forth (for example, Japanese Laid-Open Patent Publication No. 7-231420).

In a digital camera having a plurality of storage media slots, a user must select a media slot for recording a photographed image (hereinafter called the “recording slot”). However, among the plurality of media slots, there might be media slots that cannot record, for example, because there is no storage medium inserted in the slot, or because the storage medium in the slot cannot record. Consequently, there arises the possibility that the user might set the digital camera to a setting that the digital camera cannot execute. For example, when the user attempts to select a slot for a recording operation from among the plurality of media slots (that is, the recording slot), it is possible that the user might accidentally set as the recording slot a media slot that cannot be set to record. Alternatively, for example, even though only a single storage media slot is capable of recording, the user might mistakenly set the digital camera to an operating mode for executing a data back-up operation that uses a plurality of storage media.

Furthermore, when the storage medium is removed from the media slot selected as the recording slot, or that storage medium cannot be used for recording and consequently the slot status changes, that slot can no longer be used as the recording slot. In such cases, the conventional digital camera malfunctions, and consequently is unable to continue photographing until some sort of countermeasure is undertaken manually.

### SUMMARY OF THE INVENTION

An object of the present invention is to overcome the above described drawbacks.

The present invention has as one object to make it possible to enhance operability of an image sensing apparatus having a plurality of media slots.

According to one aspect of the present invention, there is provided an image sensing apparatus having a plurality of slots for inserting storage media, the image sensing apparatus comprising: a setting unit configured to set a slot selected from among the plurality of slots as a recording slot for recording image data obtained by photography; a detecting unit configured to detect whether or not recording to storage media inserted in each of the plurality of slots is possible; and a controlling configured to limit the setting unit so that those slots for which the detecting unit determines that recording to the storage media is impossible are not set as a recording slot.

Other features, objects and advantages of the present invention is apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the configuration of an image sensing apparatus according to first to third embodiments of the present invention;

FIG. 2 is a diagram illustrating a recording slot setting interface according to the first embodiment of the present invention;

FIGS. 3A, 3B, 3C and 3D are diagrams illustrating a recording slot setting automatic release according to the first embodiment of the present invention;

FIG. 4 is a flow chart showing a process of setting a media slot as a recording slot according to the first embodiment of the present invention;

FIG. 5 is a flow chart illustrating an automatic release process of recording slot setting, according to the first embodiment of the present invention;

FIG. 6 is a diagram illustrating a back-up setting interface according to a second embodiment of the present invention;

FIGS. 7A, 7B and 7C are diagrams illustrating a back-up mode automatic release according to the second embodiment of the present invention;

FIG. 8 is a flow chart illustrating a back-up mode automatic release process according to the second embodiment of the present invention;

FIG. 9 is a flow chart illustrating a back-up mode setting process according to the second embodiment of the present invention; and

FIG. 10 is a flow chart illustrating processing performed by an image sensing apparatus according to a third embodiment of the present invention.

### DETAILED DESCRIPTION OF THE INVENTION

Preferred embodiments of the present invention will now be described in detail in accordance with the accompanying drawings.

In the following embodiments, an apparatus (such as a digital camera, a digital video camera, a camera-equipped mobile telephone, etc.) that can photograph an image and record image data of the photographed image onto at least one storage medium is called an “image sensing apparatus”.

### First Embodiment

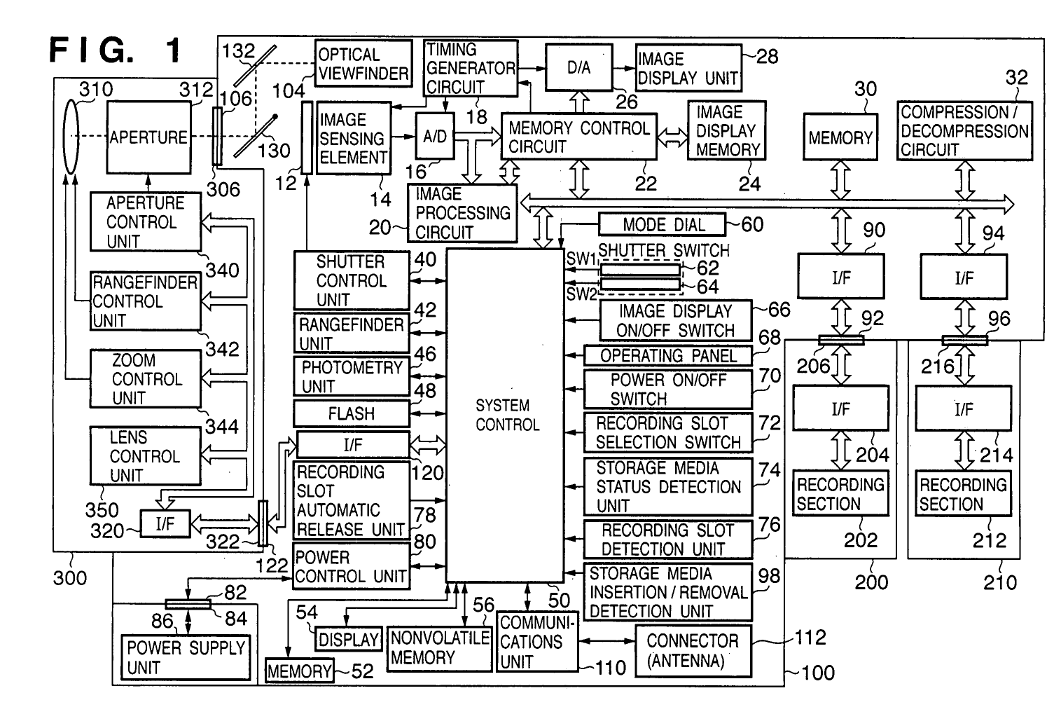

FIG. 1 is a block diagram showing the construction of an image sensing apparatus 100 according to first to third embodiments of the present invention. It should be noted that, with the image sensing apparatus of the present embodiment, it is possible to display easily a reduced image of a photographed image.

In the image sensing apparatus 100, an image sensing element 14 converts an optical image into an electrical signal. A shutter 12 is provided in order to control light exposure to the image sensing element 14. An A/D converter 16 converts analog signals output from the image sensing element 14 into digital signals. A timing generator circuit 18 supplies a clock signal and a control signal to the image sensing element 14, the A/D converter 16 and a D/A converter 26, and is controlled by a memory control circuit 22 and a system control circuit 50.

An image processing circuit 20 performs predetermined pixel interpolation processing and color conversion processing on data from the A/D converter 16 or data from the memory control circuit 22. In addition, predetermined calculations are performed in the image processing circuit 20 using sensed image data, and the results of those calculations are used by the system control circuit 50 to control a photometry unit 46 and a rangefinder unit 42. Accordingly, the foregoing arrangement makes it possible to perform such processes as AF (Auto Focus) in TTL (Through The Lens) manner, AE (Auto Exposure) and EF (Evaluative Flash (preflash)). Furthermore, predetermined calculations are performed in the image processing circuit 20 using sensed image data, and the results of those calculations are used to perform TTL AWB (Auto White Balance) as well.

It should be noted that, in the present embodiment, the rangefinder unit 42 and the photometry unit 46 are dedicated, separate units, and consequently, the present embodiment may be configured so as to perform the processes of AF (Auto Focus), AE (Auto Exposure) and EF (Evaluative Flash) using the rangefinder unit 42 and the photometry unit 46, and to not perform these process of AF (Auto Focus), AE (Auto Exposure) and EF (Evaluative Flash) using the image processing circuit 20.

The memory control circuit 22 controls the A/D converter 16, the timing generator circuit 18, the image processing circuit 20, an image display memory 24, the D/A converter 26, a memory 30 and a compression/decompression circuit 32.

An image display system is comprised of the image display memory 24, the D/A converter 26, and an image display unit 28 composed of TFT, LCD or the like. In other words, display-use image data written to the image display memory 24 is converted into video-use analog signals by the D/A converter 26 and displayed by the image display unit 28. The memory 30 stores photographed still images and moving images. The memory 30 is provided with enough capacity to store a predetermined number of images and/or a predetermined length of time of moving images. The foregoing arrangement makes it possible to write large numbers of images, at high speeds, to the memory 30. In addition, the memory 30 can also be used as a work area by the system control circuit 50.

The compression/decompression circuit 32 compresses and decompresses image data using Adaptive Discrete Cosine Transform (ADCT) or the like. The compression/decompression circuit 32 reads the images stored in the memory 30, compresses or decompresses them, and writes the processed data to the memory 30.

A shutter control unit 40 controls the shutter 12, based on photometric information from the photometry unit 46 and in tandem with an aperture control unit 340 that controls an aperture 312. It should be noted that, by working together with a flash 48, the shutter control unit 40 also has an autoflash metering function.

The rangefinder unit 42 executes rangefinding in order to perform the AF (Auto Focus) process. Light incident to a lens 310, in a single lens reflex system, is directed into the rangefinder unit 40 via the aperture 312, lens mounts 306 and 106, a mirror 130, and a rangefinding sub-mirror, not shown, as a result of which the state of focus of an image formed as an optical image can be determined. The photometry unit 46 executes AE (Auto Exposure). Light incident to the lens 310, by the single lens reflex system, is directed into the photometry unit 46 via the aperture 312, the lens mounts 306 and 106, the mirror 130, and a photometry sub-mirror, not shown, as a result of which the state of exposure of an image formed as an optical image can be determined.

The flash 48 is comprised of an AF-assist light projective function and an autoflash metering function. It should be noted that, as can be understood by those of ordinary skill in the art, the apparatus may be configured so as to perform AF control using the rangefinding results from the rangefinder unit 42 together with the results of the calculations performed by the image processing circuit 20 on the image data sensed by the image sensing element 14, and similarly, the apparatus may be configured so as to perform exposure control using the photometric results from the photometry unit 46 together with the results of the calculations performed by the image processing circuit 20 on the image data sensed by the image sensing element 14.

The system control circuit 50 exerts overall control of the image sensing apparatus 100. A memory 52 stores constants, variable, programs and the like needed for the operation of the system control circuit 50. A display instrument 54 includes a liquid crystal display device, a speaker and the like, and under the control of the system control circuit 50 outputs operating status, messages and the like using text, images and voice. The display instrument 54 is installed in one location or a plurality of locations near a control panel of the image sensing apparatus 100 that is/are easy to access visually, and may, for example, be composed of a combination of LCD, LED, sound elements, and the like. In addition, some of the functions of the display instrument 54 are disposed inside an optical viewfinder 104. A nonvolatile memory 56 is an electrically erasable/recordable nonvolatile memory, for which an EEPROM, for example, may be used.

As an operating system for inputting various types of operating instructions to the system control circuit 50, the image sensing apparatus 100 of the present embodiment is provided with a mode dial 60, shutter switches 62 and 64, an image display on/off switch, an operating panel 68, a power on/off switch 70, and recording slot selection switches 72. As an instruction input mechanism that comprises this operating system, there is a construction that utilizes mechanical contacts such as switches and dials, a construction for the purpose of pointing using a touch panel and/or sight line detection, and a voice recognition device for voice input, all of which may be used solely and individually or combined as appropriate.

A detailed description is now given of the various parts of the operating system described above. The mode dial switch 60 switches between a plurality of modes, including an automatic photographic mode, a program photographic mode, a shutter speed priority mode, an aperture priority mode, a manual photographic mode, a depth of focus priority photographic mode, a portrait photographic mode, a wide-angle photographic mode, a close-up photographic mode, a sports photographic mode, a nighttime photographic mode, a panoramic photographic mode, and so forth.

A shutter switch 62 (SWI) is turned on during operation of a shutter button (that is, when the shutter button is depressed halfway), not shown, and the resulting signal is an instruction to begin AF, AE, AWB and EF operations. In other words, the signal is an instruction to begin operation of a series of processes comprising: a process of exposure that writes signals read from the image sensing element 14 to the memory 30 as image data through the A/D converter 16 and the memory control circuit 22; a process of developing that uses the calculations performed by the image processing circuit 20 and the memory control circuit 22; and a recording process performed by reading image data from the memory 30, compressing it with the compression/decompression circuit 32, and writing the image data to storage media 200 or 210.

When the image display on/off switch 66 is turned on, that is an instruction to begin reproduction. This instruction begins the operation of reproduction, that is, reading of photographed images from the memory 30 or the storage media 200 or 210 and causing the images to be displayed by the image display unit 28. The operating panel 68 is composed of other types of buttons and touch panels, etc. The power on/off switch 70 can be set to switch between the power on and power off modes. In addition, the power on/off switch 70 can be set to switch between the power on and power off modes for peripheral devices as well, such as, for example, the storage media 200, 210 and a lens unit 300 connected to the image sensing apparatus 100, as well as an external strobe, not shown.

Using the recording slot selection switches 72, a user can select a desired slot from among the plurality of media slots to be the recording slot, and can set such selection status in the image sensing apparatus. One or more of the plurality of media slots can be selected as the recording slot(s). The recording slot selection status set by the user using the recording slot selection switches 72 is saved in the system control circuit 50 or the memory 52 as a user selection slot. It should be noted that, where selecting the recording slot with the image sensing apparatus 100, a list of the media slots may be displayed using the image display unit 28 and a desired media slot selected from the list thus displayed. Alternatively, the apparatus may be configured so that a communications unit 110 retrieves a value preset by a computer or the like and that value is selected.

A storage media status detection unit 74 detects whether or not storage media (such as the storage media 200 and 210) inserted in the storage media slot can record. A recording slot detection unit 76 searches for the media slots set as the recording slot among the plurality of media slots. A recording slot automatic release unit 78 automatically releases a media slot set as a recording slot from its status as a recording slot. In addition, when executing an automatic release, a display (or a voice output) to that effect is displayed by the image display unit 28 or the display instrument 54, thereby notifying the user that an automatic release has been executed.

A power control unit 80 is composed of a battery detection circuit, a DC-DC converter, and a switching circuit that switches the block to which power is supplied, and detects whether or not a battery is installed, the type of battery, and the remaining battery capacity. Then, based on the results of such detection and on instructions from the system control circuit 50, the power control unit 80 controls the DC-DC converter, supplying a required voltage to all parts including the storage media for a required time period.

A power supply unit 86 is comprised of a primary battery, such as an alkaline battery or a lithium battery, a secondary battery, such as a NiCd battery, a NiMH battery or a Li battery, and an AC adapter, and supplies electrical power to the power control unit 80 via the connector 82.

Interfaces 90, 94 connect a storage medium, such as a memory card or a hard disk, to a bus inside the apparatus. Connectors 92, 96 are provided on the media slots that connect to the storage medium such as a memory card or a hard disk, and are connectable to a connector that the storage medium has (such as connectors 206 and 216 of the storage media 200 and 210). A storage media insertion/removal detection unit 98 detects whether or not storage media are attached to the connectors 92 and/or 96.

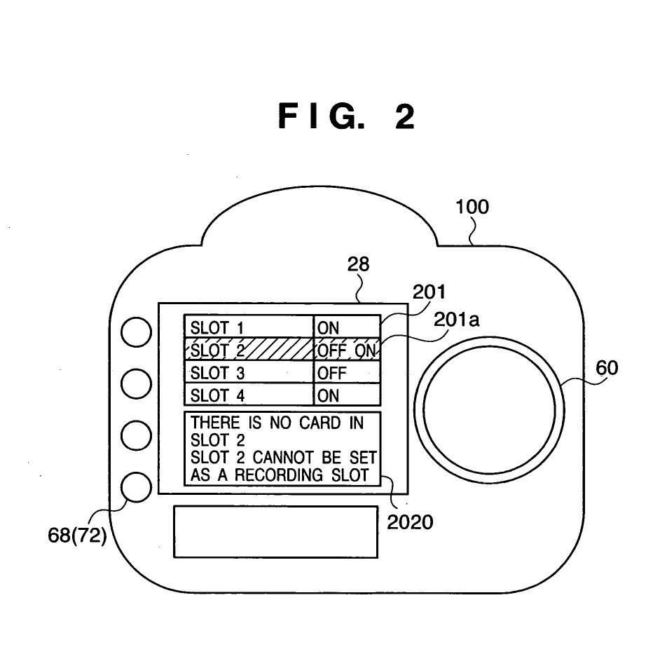

It should be noted that although FIG. 1 shows two interface and connector systems for the installation of the storage media, the number of interfaces and connectors for installing storage media may of course be three or more. In the first embodiment shown in FIG. 2 and thereafter, the description is of an instance in which the apparatus has four media slots, four connectors and four interfaces so as to connect four storage media. In addition, as the interface and connectors, that which conforms to the standards for PCMCIA (Personal Computer Memory Card International Association) cards or CF (Compact Flash (registered trademark)) may be used. Furthermore, the storage media slots may each accommodate different standards (in other words, multiple standards may coexist).

Light incident to the lens 310, in the single-lens reflex system, is directed to the optical viewfinder 104 via the aperture 312, the lens mounts 306 and 106, and mirrors 130 and 132, where the light is formed into an optical image. By so doing, it is possible to perform photography using only the optical viewfinder 104, without using an electronic viewfinder function provided by the image display unit 28. In addition, some of the functions of the display instrument 54 are provided inside the optical viewfinder 104, such as a focus display, a hand-shake warning display, a flash charged display, a shutter speed display, an f-stop display, an exposure correction display, and so forth.

The lens mount 106 mainly mechanically couples the image sensing apparatus 100 to the lens unit 300. However, contained within the lens mount 106 are a variety of functions that electrically connect the image sensing apparatus 100 to the lens unit 300.

The communications unit 110 is comprised of at least one of several communications functions, such as an RS232C or USB, IEEE1394, P1284, SCSI, modem, LAN and wireless communications. A connector 112 is used to connect the image sensing apparatus 100 to other devices through the communications unit 110. It should be noted that the connector 112 becomes an antenna in the case of a wireless communications arrangement. An interface 120 electrically connects the image sensing apparatus to the lens unit 300 through the lens mount 106. A connector 122 electrically connects the image sensing apparatus 100 to the lens unit 300. It should be noted that, in FIG. 1, for simplicity of description, the connectors 122, 322 for effecting electrical connections are shown outside the lens mount 106.

Reference numerals 130 and 132 designate mirrors, and can direct light entering the lens 310 to the optical viewfinder 104 by the single-lens reflex system. It should be noted that the mirror 132 may be constructed as either a quick-return mirror or a half mirror.

Reference numeral 200 designates a storage medium such as a memory card, a hard disk, etc. The storage medium 200 is comprised of a recording section 202 composed of a semiconductor memory or a magnetic disk, etc., an interface 204 for effecting a logical connection to the image sensing apparatus 100, and a connector 206 for effecting a physical connection to the image sensing apparatus 100. Similarly, reference numeral 210 designates a storage medium such as a memory card, a hard disk, etc., and is comprised of a recording section 202 composed of a semiconductor memory or a magnetic disk, etc., an interface 214 to the image sensing apparatus 100, and a connector 216 for connecting to the image sensing apparatus 100.

The lens unit 300 is a replaceable lens type, and is provided with a photographic lens 310 and an aperture 312. The lens unit 300 is mechanically coupled to the image sensing apparatus 100 through the lens mount 306. The connector 322 is disposed inside the lens mount 306 in order to connect the lens unit 300 electrically to the image sensing apparatus 100. In other words, the lens unit 300 is electrically communicably connected to the image sensing apparatus 100 by the connector 322 and the interface 320. The connector 322 enables control signals, status signals, data communications signals and the like to be exchanged between the image sensing apparatus 100 and the lens unit 300, and is also provided with a function to be supplied with or to supply currents of different voltages. In addition, the connector 322 may also be configured to transmit not only electrical communications but optical communications, voice communications, and so forth.

An aperture control unit 340 controls the aperture 312, based on photometric information from the photometry unit 46 and working in tandem with the shutter control unit 40 that controls the shutter 12. In addition, a rangefinder control unit 342 controls the focusing of the photographic lens 310 and a zoom control unit 344 controls the zooming of the photographic lens 310. A lens control unit 350 controls the lens unit 300 as a whole. The lens control unit 350 is also provided with a memory for recording operating constants, variable, programs and the like, as well as a nonvolatile memory function for holding identifying information such as a number or the like that is unique to the lens unit 300, management information, release f-stop value and minimum f-stop value, focal distance and other functional information, and past and present setting values and the like.

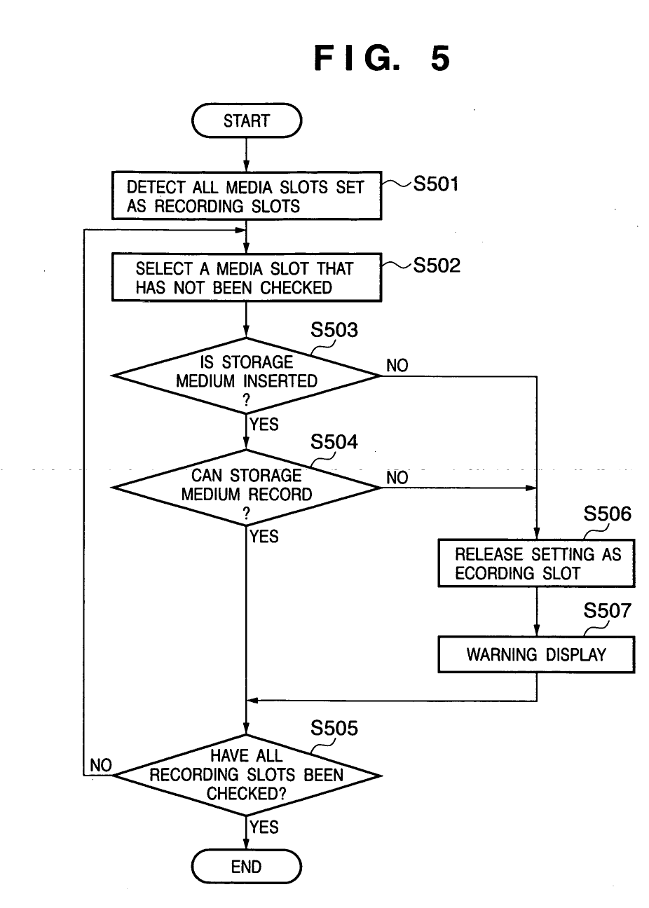

FIG. 2 is a diagram showing a view of the exterior of the image sensing apparatus 100 of the embodiment shown in FIG. 1. The image display unit 28 may for example be composed of a liquid crystal display unit, and in FIG. 2 an example of a display when setting the recording slot, is shown. A detailed description of the operation and process of setting the recording slot will be given later with reference to the flow chart shown in FIG. 5, but a simplified description follows here. When the apparatus is shifted into the recording slot setting mode using the mode dial 60, a list 201 of the media slots is displayed in the image display unit 28 and it is possible to issue an instruction at each slot whether or not to set such slot as a recording slot using the operating panel 68. Then, once the media slot displayed in the list 201 is selected using the operating panel 68 (for example 201a), the status of the selected media slot is displayed in a notification frame 2020. As the slot status notified here, there are the following options: “No storage medium inserted in media slot”, “Storage medium inserted in media slot has not been formatted”, “Storage medium inserted in media slot has insufficient capacity”, and “Storage medium inserted in media slot is damaged”.

It should be noted that, in the present embodiment, a configuration is adopted in which at least one of the plurality of slots is designated as a recording slot using the image display unit 28 to display reduced images of photographed images. However, alternatively, it is also possible to adopt a configuration that provides an interface for setting at least one of the plurality of slots as the recording slot using another liquid crystal display unit disposed on a top surface or on a rear surface of the image sensing apparatus 100.

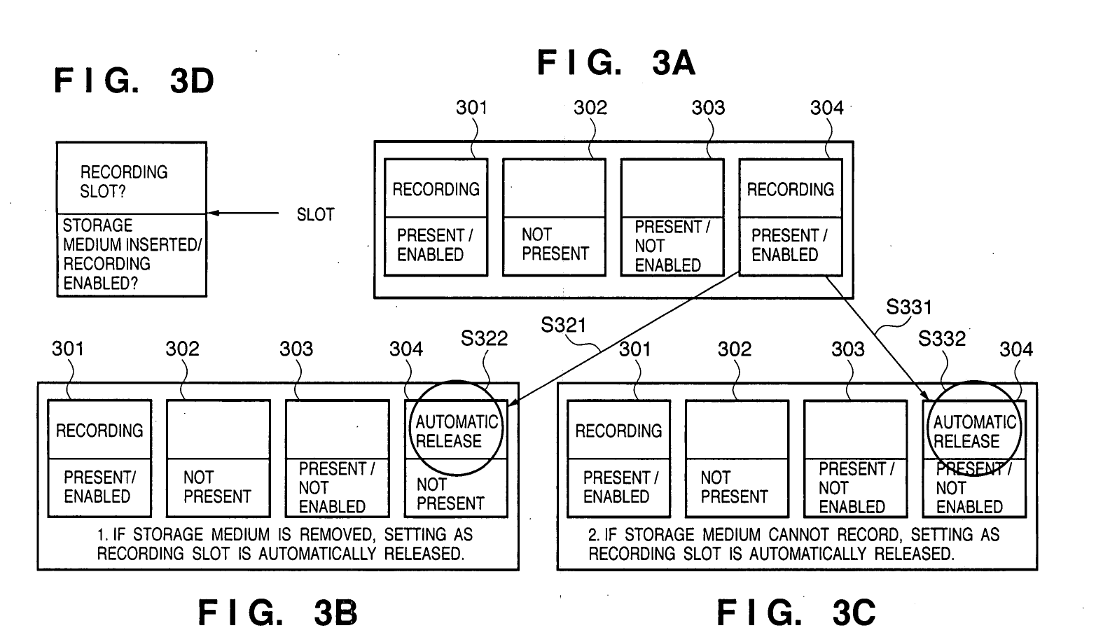

Next, a description will be given of the operation of the first embodiment, with reference to FIGS. 3A, 3B, 3C and 3D. It should be noted that the processes and operations illustrated by the flow charts below are implemented by the system control circuit 50 executing the programs stored in the memory 52.

FIGS. 3A to 3C show an example of states of media slots provided on the image sensing apparatus 100 according to the present embodiment. In FIGS. 3A to 3C, the reference numerals 301 to 304 denote media slots.

As shown in FIG. 3D, the upper halves of the media slots 301-304 show whether or not the media slot has been set as a recording slot. In FIGS. 3A to 3C, if “RECORDING” is marked in the upper half, then it indicates that the media slot is set as a recording slot.

Also, as shown in FIG. 3D, the lower halves show (1) whether or not a storage medium (memory card or the like) is connected, or (2) when a storage medium is connected, whether or not the connected storage medium can store a photographed image. In FIGS. 3A to 3C, If “NOT PRESENT” is indicated, then no storage medium is connected in the media slot. If “PRESENT” is indicated, it means that a storage medium is connected in the media slot. If “NOT ENABLED” is indicated, it means that the storage medium connected in the recording medium can not record any more photographed image. The image sensing apparatus 100 determines that the storage medium can not record photographed image when the storage medium is broken, the storage medium does not have enough capacity for recording a photographed image, the storage medium has not been initialized yet, or the like. If “ENABLED” is indicated in the lower half of the slot in FIGS. 3A to 3C, it means that the storage medium connected in the media slot can record a photographed image.

It should be noted that although the image sensing apparatus in the present embodiment has four media slots, the operation explained below can be applied to an image sensing apparatus having more than two media slots.

A recordable storage medium is inserted into the media slot 301, and further, the media slot 301 is selected as a recording slot. No storage medium is inserted into the media slot 302, nor is the slot selected as a recording slot. A storage medium is inserted in media slot 303, but the storage medium cannot record, and the slot is not selected as a recording slot. Like media slot 301, a recordable storage medium is inserted in media slot 304, and the slot is selected as a recording slot.

In the image sensing apparatus 100 in a setting status like that shown in FIG. 3A above, when the operation for setting a recording slot is performed, the image display unit 28 shows a display like that shown in FIG. 2 (wherein the media slots 301-304 correspond to slots 1-4 shown in FIG. 2). In FIG. 3A, the media slot 302 and the media slot 303 are both in a state in which the execution of recording to the storage medium is impossible, because the slots are in states in which “No storage medium inserted in slot” and “Storage medium cannot record”, respectively. In the present embodiment, the setting of such slots, for which it is determined that the execution of recording is impossible, as recording slots is prohibited. While the switching the selection statuses of the media slots shown in the list 201 using the operating panel 68, if a media slot that has been selected cannot be set as a recording slot, then a message to that effect is displayed in the notification frame 2020. In FIG. 2, slot 2 (corresponding to media slot 302 in FIG. 3) is selected (201a) from the list 201, and the user is notified that no storage medium is inserted in slot 2 by a message to that effect displayed in the notification frame 2020.

In addition, in the image sensing apparatus 100 operating in a recording slot setting state like that shown in FIG. 3A above, the status of the media slot changes as shown in FIG. 3B. In other words, the storage medium is removed from the media slot 304, changing the status of media slot 304 to one in which no storage medium is inserted therein (S321). It should be noted that the change in status of the media slot 304 to a state in which no storage medium is inserted therein is detected by the storage media insertion/removal detection unit 98. It should be noted that methods for the detection of the insertion/removal of a storage medium are well known, and therefore a description thereof is omitted herein. At this time, there is no storage medium inserted in the media slot 304, and therefore it is impossible for the slot to record a photographed image and it is necessary to release the slot from its setting as a recording slot. Accordingly, the media slot 304 is automatically released from its setting as a recording slot (S322).

FIG. 3C shows a change from the state shown in FIG. 3A to a state in which the storage medium inserted in media slot 304 cannot record (S331). It should be noted that the change to a state in which the storage medium cannot record is detected by the storage media status detection unit 74. An inability to record may result from the storage medium being damaged, the storage medium being filled to capacity, or the storage medium not being formatted. Methods for the detection of such a state are well known and a description thereof is omitted herein. In the present case, in which media slot 304 cannot be used to record a photographed image, it is necessary to release media slot 304 from its setting as a recording slot. Accordingly, the setting of the media slot 304 as a recording slot is automatically released (S332).

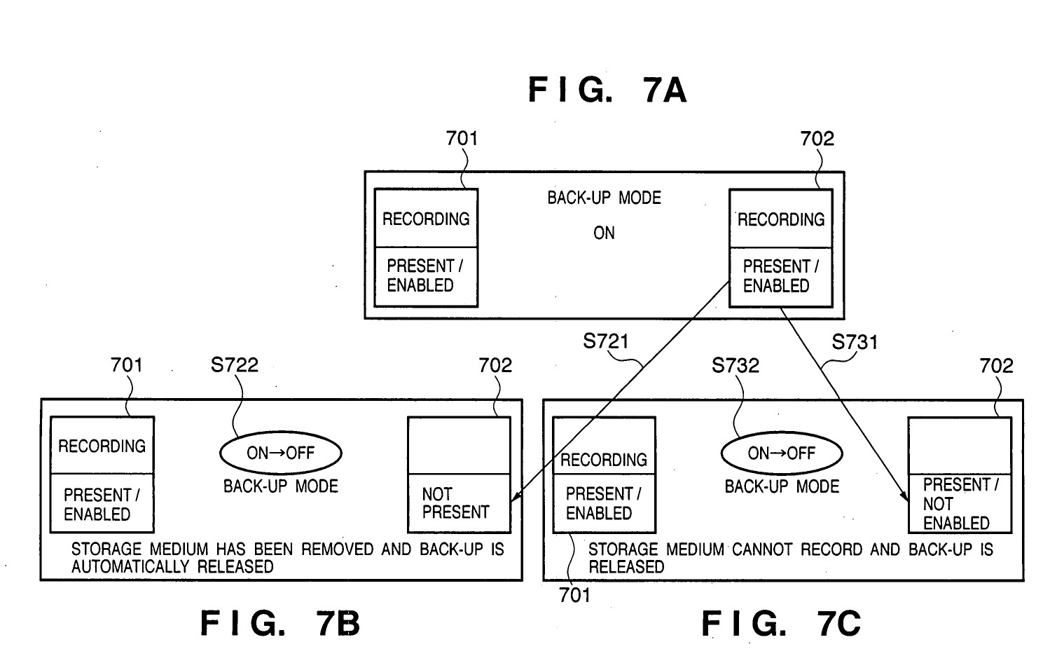

It should be noted that, when executing the automatic release of steps S322 and S332 shown in FIG. 7, a message to that effect is displayed in the image display unit 28, thus notifying the user of a change in the setting status of the media slot (that is, that the media slot has been released from its setting as a recording slot).

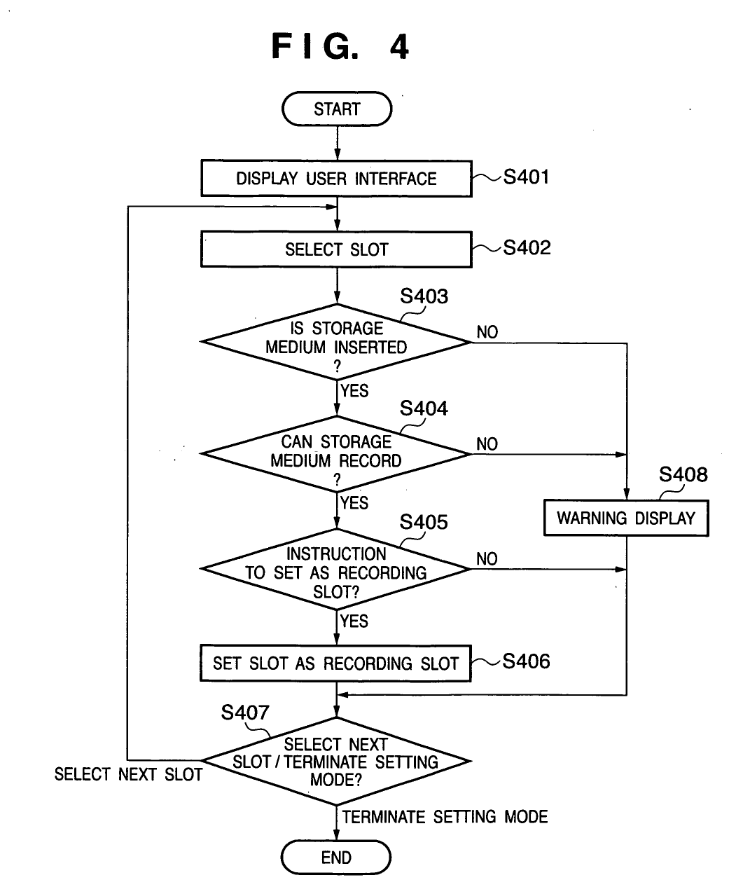

The above-described operation will now be described in further detail with reference to the flow charts shown in FIG. 4 and FIG. 5.

FIG. 4 is a flow chart illustrating the operation of the image sensing apparatus 100 when setting a storage media slot as a recording slot. Using FIG. 4, a description is given of a process and a warning display when selecting a desired slot as a recording slot. It should be noted that the process shown in FIG. 4 is initiated by setting the image sensing apparatus 100 to the recording slot setting mode using the mode dial 60.

When the recording slot setting mode process is activated, first, in a step S401, the user interface is displayed by the image display unit 28. Here, a media slot list display 201 like that shown in FIG. 2 is displayed. It should be noted that the settings of each of the media slots to a status as a recording slot are displayed in the list display 201 for all the media slots that the image sensing apparatus possesses. In addition, when displaying this list, these states are detected by the storage media insertion/removal detection unit 98 and the storage media status detection unit 74 and the results of that detection may be displayed. By so doing, the user can tell at a glance which media slots may be set as recording slots, thus further improving operability. It should be noted that, by shifting to the recording slot setting mode, some of the operating switches of the operating panel 68 shown in FIG. 2 function as recording slot setting switches 72.

Using the recording slot setting switches 72, the user can switch between the media slots that have been selected from the list display 201 (step S402). When a media slot is put into a selected state (highlighted) like media slot 201a in the list display 201, the storage media insertion/removal detection unit 98 checks the selected slot to determine whether or not a storage medium is present in the slot (step S403). If it is determined in step S403 that a storage medium is not inserted in the slot, then processing proceeds to step S408 and a warning is displayed using the image display unit 28 or the like. In the present embodiment, as shown in FIG. 2, a message to that effect is displayed in the notification frame 2020. Processing then proceeds to step S407. In the present case, a step S406 to be described later is skipped, and therefore the setting of such media slot as a recording slot is prohibited.

By contrast, if it is determined that a storage medium is inserted in the slot, then processing proceeds from step S403 to step S404 and the storage media status detection unit 74 checks the status of the storage medium inserted in the media slot (that is, determines whether or not the storage medium can record). If it is determined that the storage medium inserted in the media slot cannot record, then processing proceeds to step S408 and a message to that effect is displayed in the notification frame 2020. Processing then proceeds to step S407. In the present case as well, the step S406 to be described later is skipped, and therefor the setting of the slot as a recording slot is prohibited. In other words, a media slot for which the storage media insertion/removal detection unit 98 and the storage media status detection unit 74 determine that recording to the storage medium inserted therein is impossible, setting thereof as a recording slot is prohibited.

In step S404, if it is determined that the storage medium inserted in the media slot can record, then processing proceeds to step S405. Where processing proceeds to step S405, the setting of the media slot as a recording slot is impossible, and therefore it is determined whether or not the recording slot selection switches 72 have issued a message indicating setting as a recording slot. If an instruction setting the slot as a recording slot has been issued, then processing proceeds to step S406, the media slot is set as a recording slot, and that status is stored in the memory 52. Where there has been input of an instruction to move to select the next media slot, processing proceeds to step S407 from step S402 and the process described above is repeated for the newly selected media slot. Where there has been input of an instruction to release the recording slot setting mode, processing terminates after step S407.

It should be noted that, where it is determined that the selected media slot can be set as a recording slot, then processing returns to step S405 until there is an instruction to select the next media slot or there is an instruction to terminate the setting mode in step S407. By contrast, where a warning is displayed in step S408 and processing proceeds to step S407, the apparatus enters a standby mode in step S407, until there is an instruction to select the next media slot or there is an instruction to terminate the setting mode.

The foregoing is a description of the process of setting a particular media slot as a recording slot in the present embodiment. A description is now given of control of the recording slot setting status attendant upon a change in status of the media slot, with reference to the flow chart shown in FIG. 5.

FIG. 5 shows a flow chart illustrating monitoring of the status of the media slots and automatic release of the recording mode in the image sensing apparatus 100 according to the present embodiment. For example, where the status of a given media slot changes from the state shown in FIG. 3A to that shown in FIG. 3B or 3C, a process of automatically releasing the setting as a recording slot of that media slot for which recording is impossible is included. It should be noted that the process shown in FIG. 5 is repeatedly executed in predetermined cycles during operation of the image sensing apparatus 100. Alternatively, the process shown in FIG. 5 may be executed whenever either the storage media insertion/removal detection unit 98 or the storage media status detection unit 74 detects a change in the status of the media slot.

First, in step S501, the recording slot detection unit 76 checks the memory 52 and detects all media slots set as recording slots. In step S502, a media slot which has not been checked yet is selected from the media slots detected in step S501. In step S503, the storage media insertion/removal detection unit 98 the selected media slot for the presence of a storage medium. If it is determined that there is no storage medium in the media slot checked, then processing proceeds to step S506 and the selected media slot is released from its setting status as a recording slot by the recording slot automatic release unit 78. Then, in step S507, a message indicating that the automatic release has been carried out and the reason therefor is displayed using the image display unit 28.

If it is determined in step S503 that a storage medium is inserted in the media slot, then processing proceeds to step S504. In step S504, the storage media status detection unit 74 determines whether or not the storage medium inserted in the media slot can record. If it is determined that the storage medium inserted in the media slot cannot record, then processing proceeds to steps S506 and S507 and the media slot is released from its setting as a recording slot (in steps corresponding to S322, S332 shown in FIG. 3), and a warning to that effect as well as the reason therefor are displayed.

If it is confirmed that a recordable storage medium is inserted in the selected media slot, then the setting status of that media slot as a recording slot is maintained. Then, in step S505, a check is made to determine if there remain any unchecked media slots, and if so, the processe proceeds to step S502 to check the next media slot. If checking of all the slots dtected in step S501 is completed, then processing terminates.

While executing the above-described monitoring of the recording slots as shown in FIG. 5, where a photographic operation has been executed, for all media slots set as recording slots, image data is written to the storage media. It should be noted that, provided efforts are made to accommodate the insertion of storage media of different formats in the media slots, it is possible to record image data onto several different types of storage media simultaneously.

Thus, as described above, according to the present embodiment, the setting of a media slot as a recording slot is maintained or released depending on whether or not there is a storage medium inserted in the media slot and on the state of the storage medium inserted in the media slot. Accordingly, even when the recording slot changes to a state in which recording is impossible, there is no need for the user to manually reset the slot setting and hence the user can be relieved of this inconvenience. In addition, when an automatic release is executed, a message to that effect is displayed to the user, and therefor the user can easily ascertain that a media slot has been released from its setting status as a recording slot, which is convenient.

Moreover, if there is no storage medium inserted in the media slot, or if the storage medium cannot record, then the setting of such media slot as a recording slot is prohibited, and a message to that effect is displayed. As a result, it is possible to prevent a mistaken designation of such a media slot as a recording slot. In addition, from the display, the user can easily see that there is no storage medium inserted in the media slot, or that the storage medium that is inserted in the media slot cannot record.

### Second Embodiment

In a first embodiment of the present invention, a method of setting a plurality of media slots as recording slots by setting each of the media slot separately as a recording slot is shown. By contrast, in a second embodiment of the present invention, a method of setting a plurality of media slots as recording slots by setting a back-up mode on or off is described. It should be noted that, in the second embodiment, a description is given using an arrangement in which two media slots are provided as one example of a plurality of media slots. A description will be given later of an expansion to three or more media slots.

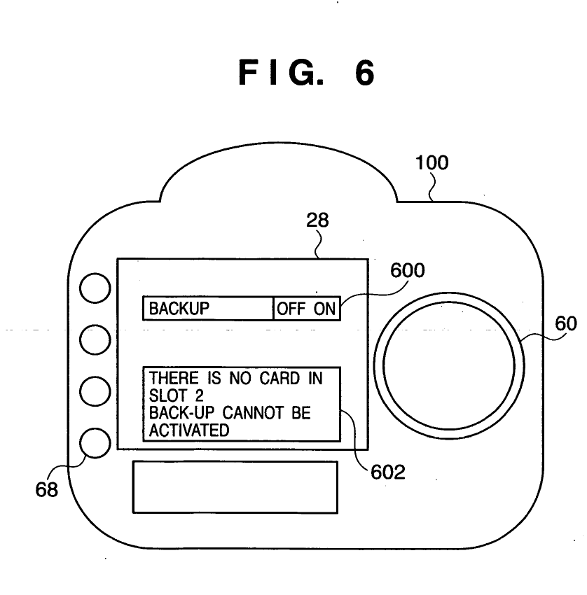

FIG. 6 is a diagram showing a sample display of the image display unit 28 of the image sensing apparatus 100 of the present embodiment during setting of the back-up mode.

When the back-up mode setting is selected using the mode dial 60, the back-up mode can be set to on or off using the operating panel 68. If the back-up mode is set to on, both of two media slots (a first slot and a second slot) are set as recording slots. If the back-up mode is set to off, then, by the method shown in the first embodiment, the user sets either the first slot or the second slot as the recording slot, or sets both slots as recording slots.

FIG. 7A to 7C show an example of the status of the media slots in the present embodiment. It should be noted that, in the present embodiment, there are two media slots. However, as described above, it is sufficient if there are two or more media slots, for the operation is the same regardless of the number of media slots.

In FIGS. 7A to 7c, the reference numerals 701 and 702 indicate media slots. The upper halves and the lower halves of the media slots 701 and 702 indicate the same meanings as the slots 301 to 304 in FIGS. 3A to 3C. In the state shown in FIG. 7A, storage media capable of recording are inserted in media slots 701, 702 and the back-up mode is turned on. Therefore, both media slots 701, 702 are set as recording slots. When photographing in such a state, the photographed data is written to the storage media in both media slot 701 and media slot 702. It should be noted that, in general, in the back-up mode, each media slot can be set as a main slot for writing the photographed image or as a back-up slot for writing back-up data. In the present case, media slot 701 is set as the main slot and media slot 702 is the back-up slot.

FIG. 7B shows a state in which the storage medium is removed from media slot 702 in FIG. 7A and the status of media slot 702 has changed to a state in which there is no storage medium in the slot (S721). As a result, media slot 702 is unable to record photographed images because no storage medium is inserted in the media slot 702. Consequently, there is no longer any back-up slot. In other words, because it is no longer possible to continue the back-up operation, where the back-up mode has been set to on, the back-up mode is automatically released, that is, tuned off, by the recording slot automatic release unit 78 (S722). Therefore, if photography occurs after the process described above, in other words, in the state shown in FIG. 7B, the photographed image is recorded only on the storage medium inserted in media slot 701.

FIG. 7C shows a state in which the state of the media slot 702 in FIG. 7A has changed and the slot cannot record. An inability to record may result from the storage medium being damaged, the storage medium being filled to capacity, or the storage medium not being formatted. At this time, it is impossible to record photographed images using media slot 702. Accordingly, if it has become impossible to continue back-up and the back-up mode has been set to on, then the recording slot automatic release unit 78 automatically releases the back-up mode, that is, turns the back-up mode off (S732). If photography occurs after the process described above, in other words, in the state shown in FIG. 7C, the photographed image is recorded only on the storage medium inserted in media slot 701.

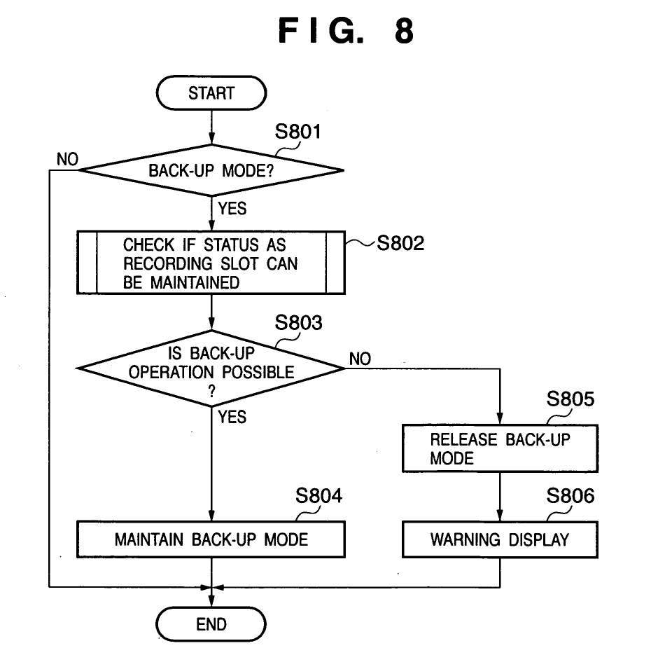

FIG. 8 is a flow chart illustrating the back-up mode automatic release process described above. The process shown in FIG. 8 is repeatedly executed in predetermined cycles during operation of the image sensing apparatus 100. Alternatively, the process shown in FIG. 8 may be executed whenever either the storage media insertion/removal detection unit 98 or the storage media status detection unit 74 detects a change in the status of the media slot.

First, in a step S801, it is determined whether or not the back-up mode is currently set. If the back-up mode is not set, then the process shown in FIG. 8 terminates. If the back-up mode is set, then processing proceeds to step S802, a check is made to determine whether or not all the media slots set as recording slots can maintain their settings as recording slots, and those media slots set as recording slots that cannot maintain their settings as recording slots are automatically released from their settings as recording slots. This operation is achieved by the processes performed in steps S501-S505 shown in FIG. 5. The display process of step S507 enables the user to determine with ease which media slots are no longer recording slots.

Then, in a step S803, it is determined whether or not a back-up can be executed by the media slots remaining as recording slots. In the example shown in FIGS. 7A, 7B and 7C, there are two media slots, and therefore if either one of these two media slots is no longer a recording slot it will become impossible to continue back-up. That is, the back-up can not be maintained if the number of recording slots is equal to or less than one. In that case, processing proceeds to step S805 and the back-up mode is released (S722, S732 shown in FIG. 7). Then, in step S806, a warning to that effect is displayed and processing terminates.

By contrast, if back-up is possible due to a combination of the media slots remaining as recording slots, then processing proceeds to step S804 and the back-up operation is continued.

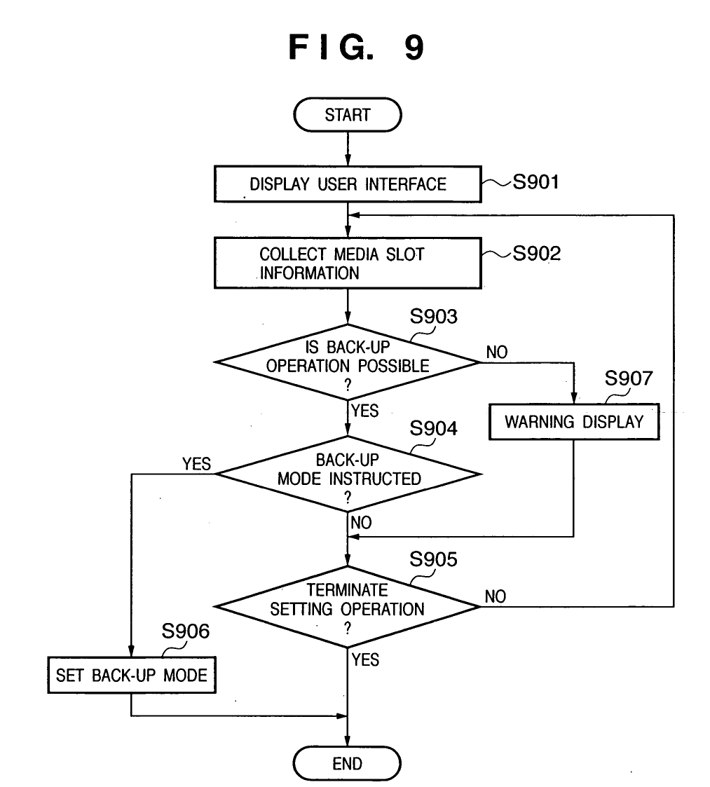

Next, a description is given of the operation of the image sensing apparatus 100 when setting the back-up mode, with reference to the flow chart shown in FIG. 9. The process shown in FIG. 9 starts when the mode dial 60 is used to designate the back-up mode setting mode.

First, in step S901, a screen is displayed showing the back-up mode setting operation, for example, a screen showing a display like that indicated by reference numeral 600 inside the image display unit 28 shown in FIG. 6. Processing then proceeds to step S902 and the status of all media slots is checked. In step S903, it is determined whether or not back-up can be performed by those media slots that can record. Here, those media slots that can record are those media slots in which recordable storage media have been inserted, and which can be identified from the results of detections performed by the storage media insertion/removal detection unit 98 and the storage media status detection unit 74.

In the event that two or more media slots that can record do not exist, the apparatus cannot operate in back-up mode. Alternatively, if the media slot designated as the main slot cannot be set as a recording slot, or if the media slot designated as the back-up slot cannot be set as a recording slot, then it is determined that the apparatus cannot operate in back-up mode. When it is determined in step S903 that the apparatus cannot operate in back-up mode, processing proceeds to step S907 and, as shown for example in FIG. 6, a warning to that effect is displayed. Where a plurality of recordable media slots are detected, processing proceeds to step S904 and it is determined whether or not there has been an instruction to shift to back-up mode. If there is an instruction to shift to back-up mode, then processing proceeds to step S906 and the apparatus is set to back-up mode. If there is no instruction to shift to back-up mode, then the processes of from step S902 to S904 described above are repeated until there is an instruction to terminate the setting operation. Thus, as described above, in the back-up mode setting mode, even if storage media are newly inserted and the number of recordable media slots thus increased, it is still possible to obtain setting and processing that promptly reflect such changes.

Thus, as described above, according to the second embodiment of the present invention, image data can be recorded to a plurality of storage media simply by setting the back-up mode, thus improving operability. In addition, in the event that image data cannot be recorded to the plurality of storage media, a warning to that effect is displayed and at the same time the back-up mode is released, thus enabling the user to ascertain accurately the operating state of the camera.

It should be noted that, in the above-described second embodiment, if the number of media slots is expanded to three or more, each individual media slot is set in advance as either a main slot or a back-up slot. Such setting may be performed by the user or may be fixed in the apparatus. Then, in step S803 and step S903, if all the media slots set as main slots are unable to record to the storage media inserted therein, or if the all the media slots set as back-up slots are unable to record to the storage media inserted therein, it may be determined that it is impossible to execute a back-up mode operation.

It should be noted that, in the image sensing apparatus according to the above-described embodiment, the program and related data are supplied by inserting a floppy (registered trademark) disk, CD-ROM or other such storage medium into the storage medium drive insertion slot provided in the apparatus, and the program and related data temporarily installed from the storage medium to the hard disk and loaded into the RAM, or loaded directly into the Ram without being installed on the hard disk, with the program executed by executing the program and related data. Alternatively, the program can be executed by storing the program and related data in the image sensing apparatus in advance.

### Third Embodiment

In the first and second embodiments described above, an image sensing apparatus is explained, in which, if a particular setting can no longer be maintained due to the state of the media slot, that setting is automatically released. For example, in the first embodiment, if the media slot set as the recording slot cannot record, its setting as a recording slot is automatically released (S503, S504, S506, S507). In addition, in the second embodiment, if either the main slot or the back-up slot no longer operates as a recording slot, the back-up mode is automatically released (S803, S805, S806).

In a third embodiment of the present invention, an image sensing apparatus is explained, in which, before such a release is performed, the user is given the opportunity to return a given media slot to a selected slot. In the third embodiment, like the first and second embodiments, the image sensing apparatus has the structures as shown in FIG. 1.

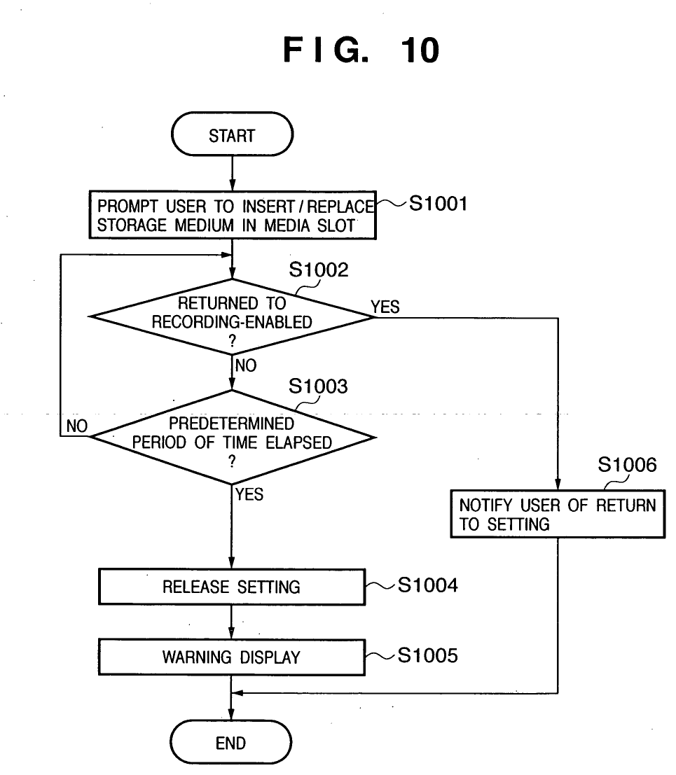

FIG. 10 is a flow chart illustrating processing by a third embodiment of the present invention. The process shown in FIG. 10 is substituted for steps S506 and S507 in the first embodiment. Also, alternatively, the process shown in FIG. 10 can be substituted for steps S805 and S806 in the second embodiment.

First, referring to FIG. 10, a case where a part of the configuration of the first embodiment is modified will be explained.

If NO in the step S503 or step S504 (if a selected media slot is unable to record), the image sensing apparatus initiates the processing of the step S1001 shown in FIG. 10. In step S1001, a message or the like is displayed on the image display unit 28 to prompt the user to insert or replace a storage medium. At this time, the selected media slot is indicated to the user by using an icon or the like.

If the selected media slot returns to recording-enabled status within a predetermined period of time, processing proceeds from step S1002 to step S1006. In step S1006, a message or the like which notifies that the recording slot setting has not been released is displayed on the image display unit 28. Then the processing proceeds to step S505 shown in FIG. 5. By contrast, if the media slot does not return to recording-enabled status within a predetermined period of time, then processing proceeds to step S1004, the recording slot setting is released and a message or the like warning to that effect is displayed on the image display unit 28, in step S1005. Processing then proceeds to step S505.

Next, referring to FIG. 10, a case where a part of the configuration of the second embodiment is modified will be explained below. In this case, in step S1002, it is not determined whether the selected media slot has returned to recording-enabled status, but determined whether the status in which back-up operation can be performed has returned.

If it is determined that, in the step S803, back-up operation cannot be continued, the image sensing apparatus 100 initiates the processing of the step S1001 shown in FIG. 10. In step S1001, in order to be able to maintain the back-up mode, a message or the like prompting the user to insert or replace the storage medium in the selected media slot is displayed on the image display unit 28. At this time, a media slot that is not set as a recording is indicated to the user by using an icon or the like.

If the status in which the back-up operation can be performed returned within a predetermined period of time, processing proceeds from step S1002 to step S1006. In the step S1006, a message or the like indicating that the back-up mode has not released is displayed on the image display unit 28. By contrast, if the status in which the back-up operation can be performed has not returned within the predetermined period of time, processing proceeds to step S1004, the back-up mode is released and a message or the like warning that effect is displayed on the image display unit 28.

As described above, according to the third embodiment of the present invention, if a storage medium is inserted or replaced within the predetermined period of time, there is no longer any need to redo recording slot setting operation or back-up mode setting operation, thus improving operability.

It should be noted that, instead of waiting for the predetermined period of time to elapse, the apparatus may be configured so as to determine whether or not the user has consented to release from a recording slot setting or a back-up mode setting. In that case, the processing may be modified as follows. In the step S1003, a message or the like inquiring whether or not the user consents to a release of the recoding slot setting or the back-up mode setting, is displayed on the image display unit 28. If there is an operation input indicating that the user consents to the release of the recording slot setting or the back-up mode setting, the processing proceeds from step S1003 to step S1004.

As many apparently widely different embodiments of the present invention can be made without departing from the spirit and scope thereof, it is to be understood that the invention is not limited to the specific preferred embodiments described above thereof except as defined in the claims.

### CLAIM OF PRIORITY

This application claims priority from Japanese Patent Applications No. 2004-031406 filed on Feb. 6, 2004 and No. 2005-023940 filed on Jan. 31, 2005, which are incorporated herein by reference.

1. An image sensing apparatus having a plurality of slots for inserting storage media, the image sensing apparatus comprising:
a setting unit configured to set a slot selected from among the plurality of slots as a recording slot for recording image data obtained by photography;
a detecting unit configured to detect whether or not recording to storage media inserted in each of the plurality of slots is possible; and
a controlling configured to limit said setting unit so that those slots for which the detecting unit determines that recording to the storage media is impossible are not set as a recording slot.

2. The apparatus according to claim 1, wherein said controlling unit comprises a notification configured to notify a user of a slot for which the detecting unit determines that recording to the storage medium is not possible if the recording slot is set using the setting unit.

3. The apparatus according to claim 1, wherein said detecting unit comprises a first detection unit for detecting the presence of storage medium in each of the slots and a second detection unit for detecting whether or not image data can be recorded to the storage media in the slot in which the first detection unit detects the presence of a storage medium.

4. An image sensing apparatus having a plurality of slots for inserting storage media, the image sensing apparatus comprising:
a detecting unit configured to detect whether or not it is possible to record to a storage medium in a slot set from among the plurality of slots as a recording slot for recording image data acquired by photography; and
a release unit configured to automatically release a setting status as a recording slot for any slot for which said detecting unit determines that recording to the storage medium is not possible.

5. The apparatus according to claim 4, wherein the release unit comprises a notification unit configured to notify a user of a slot whose setting status as a recording slot setting is released.

6. The apparatus according to claim 4, wherein said detecting unit comprises a first detection unit for detecting the presence of storage medium in each of the plurality of slots and a second detection unit for detecting whether or not image data can be recorded to the storage media in the slot in which the first detection unit detects the presence of a storage medium.

7. The apparatus according to claim 4, wherein, if there exists a slot for which the detecting unit determines that recording to the storage medium is impossible, the release unit executes an automatic release of the recording slot setting of such slot after a predetermined delay time elapses, and prohibits such automatic release if such slot for which the detecting unit determines that recording to the storage medium is impossible enters a recording-enabled state before such predetermined delay time elapses.

8. The apparatus according to claim 4, wherein, if there exists a slot for which the detecting unit determines that recording to the storage medium is impossible, the release unit executes an automatic release of the recording slot setting of such slot after a predetermined operation input, and prohibits such automatic release if such slot for which the detecting unit determines that recording to the storage medium is impossible enters a recording-enabled state before such predetermined operation input.

9. An image sensing apparatus having a plurality of slots for inserting storage media, the image sensing apparatus comprising:
a setting unit configured to set slots selected from among the plurality of slots to recording slots for recording image data acquired by photography in response to an instruction to set to a back-up mode;
a detecting unit configured to detect whether or not recording to storage media inserted in each of the selected plurality of slots is possible;
a determining unit configured to determine whether or not it is possible to execute a back-up operation based on detection results obtained by the detecting unit regarding the slots selected by the setting unit; and
a controlling unit configured to prohibit setting to said back-up mode where said determining unit determines that the back-up operation cannot be executed.

10. The apparatus according to claim 9, wherein the controlling unit comprises a notification unit configured to notify a user that setting to said back-up mode is prohibited.

11. The apparatus according to claim 9, wherein:
the back-up operation is carried out using, from among the plurality of slots, a slot set as a main recording slot and a slot set as a back-up recording slot in said back-up mode; and
said determining unit determines that back-up is impossible if the detecting unit determines that there is no slot which can record to a recording medium in either the slots set as the main recording slot or the slot set as the back-up recording slot.

12. An image sensing apparatus having a plurality of slots for inserting storage media, the image sensing apparatus comprising:
a setting unit configured to set slots selected from among said plurality of slots as recording slots for recording image data obtained by photography in response to an instruction to set to a back-up mode;
a detecting unit configured to detect whether or not recording to storage media inserted in each of the selected slots is possible;
a determining unit configured to determine whether or not it is possible to execute a back-up operation based on detection results obtained by the detecting unit regarding the plurality of slots selected by the setting unit; and
a release unit configured to automatically release said back-up mode where, during back-up mode operation, the determining unit determines that back-up operation cannot be performed.

13. The apparatus according to claim 12, further comprising a notification unit configured to notify a user if the release unit releases the back-up mode.

14. The apparatus according to claim 12, wherein:
the back-up operation is carried out using, from among the plurality of slots, a slot set as a main recording slot and a slot set as a back-up recording slot in said buffer mode; and
said determining unit determines that back-up is impossible if the detecting unit determines that there is no slot which can record to a recording medium in either the slots set as the main recording slot or the slots set as the back-up recording slot.

15. The apparatus according to claim 12, wherein said release unit executes the release of the back-up mode after a predetermined delay time elapses if the determining unit determines that back-up is impossible, and prohibits such release if the slot for which the detecting unit determines that back-up is impossible enters a back-up-enabled state before such predetermined delay time elapses.

16. The apparatus according to claim 12, wherein said release unit executes the release of the back-up mode after a predetermined operation input if said determining unit determines that back-up is impossible, and prohibits such release if the slot for which said determining unit determines that back-up is impossible enters a backup-enabled state before such predetermined operation input.

17. A control method for an image sensing apparatus having a pluraliy of slots for inserting storage media, the control method comprising the steps of:
setting a slot selected from among said plurality of slots as recording slots for recording image data obtained by photography;
detecting whether or not recording to storage media inserted in each of the plurality of slots is possible; and
limiting said setting step so that those slots for which the detecting step determines that recording to the storage media is impossible are not set as recording slots.

18. A control method for an image sensing apparatus having a plurality of slots for inserting storage media, the control method comprising the steps of:
detecting whether or not it is possible to record to a storage medium in a slot set from among the plurality of slots as a recording slot for recording image data acquired by photography; and
automatically releasing a setting status as a recording slot for any slot for which said detecting step determines that recording to the storage medium is not possible.

19. A control method for an image sensing apparatus having a plurality of slots for inserting storage media, the control method comprising the steps of:
setting slots selected from among the plurality of slots to recording slots for recording image data acquired by photography in response to an instruction to set to a back-up mode;
detecting whether or not recording to storage media inserted in each of the selected slots is possible;
determining whether or not it is possible to execute a back-up operation based on detection results obtained in the detection step regarding the slots selected in the setting step; and
prohibiting setting to said back-up mode where said determination step determines that the back-up operation cannot be executed.

20. A control method for an image sensing apparatus having a plurality of slots for inserting storage media, the control method comprising the steps of:
setting slots selected from among said plurality of slots as recording slots for recording image data obtained by photography in response to an instruction to set to a back-up mode;
detecting whether or not recording to storage media inserted in each of the selected slots is possible;
determining whether or not it is possible to execute a back-up operation based on detection results obtained in the detecting step regarding the slots selected in the setting step; and
automatically releasing said back-up mode where, during back-up mode operation, the determining step determines that back-up operation cannot be performed.

21. A control program for causing a computer to execute the control method according to claim 17.

22. A storage medium storing a control program for causing a computer to execute the control method according to claim 17.
